(19) United States
(12) Patent Application Publication
(10) Pub. No.: US 2014/0074526 A1
(43) Pub. Date: Mar. 13, 2014

(54) SYNCHRONIZING DATA RELATED TO WORKFLOW

(71) Applicant: OLIVIER CAUDRON, FOURQUEUX (FR)

(72) Inventor: OLIVIER CAUDRON, FOURQUEUX (FR)

(21) Appl. No.: 13/615,576

(22) Filed: Sep. 13, 2012

(51) Int. Cl. G06Q 10/06

(52) U.S. Cl. 705/7.13

(57) ABSTRACT

In an embodiment, an image of a printed card is received at a client device. Printed card contains information related to a task along with a unique identifier to identify the task. The unique identifier is extracted from the received image of the printed card and the task corresponding to the unique identifier is identified. Based on the identified task, associated workflow is determined and a set of actions corresponding to the workflow is retrieved and displayed to the user. User selected action is received, along with other inputs, to update information associated with the selected action. The updated information is stored in a memory corresponding to the task.

### BACKGROUND

In a typical development environment, various types of project management strategies are used to plan, organize, manage and control resources to meet specific goals or project requirements. There are a number of approaches for managing project activities including lean, iterative, incremental, and phased approaches. For example, in an iterative project management approach, teams use agile practices such as feature driven development, scrum, etc., which normally involve modeling sessions. In general, such modeling happens on a physical dashboard to support understanding, communication and collaboration among the team members. Such modeling on a physical dashboard can be cumbersome and non-scalable to manage and track projects.

### SUMMARY

Various embodiments of systems and methods for synchronizing data related to workflow are described herein. In one embodiment, the method receives an image of a printed card at a client device. Printed card contains information related to a task along with a unique identifier to identify the task. The unique identifier is extracted from the received image of the printed card and the task corresponding to the unique identifier is identified. Based on the identified task, associated workflow is determined and a set of actions corresponding to the workflow is retrieved and displayed to the user. User selected action is received, along with other inputs, to update information associated with the selected action. The updated information is stored in a memory corresponding to the task.

These and other benefits and features of embodiments will be apparent upon consideration of the following detailed description of preferred embodiments thereof, presented in connection with the following drawings.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an overview of an exemplary environment for synchronizing data, according to an embodiment.

FIG. 2 illustrates a user interface for displaying tasks, according to one embodiment.

FIG. 3 illustrates a workflow that is associated with a task, according to one embodiment.

FIG. 4 illustrates a user interface for generating print ready card for the task, according to one embodiment.

FIG. 5 illustrates a user interface displaying a set of actions associated with a workflow, corresponding to a scanned printed card, according to one embodiment.

FIG. 6 illustrates a user interface displaying information associated with a selected action, according to one embodiment.

FIG. 7 illustrates a user interface displaying updated tasks, according to one embodiment.

FIG. 8 illustrates a flow diagram of a method for synchronizing data, according to one embodiment.

FIG. 9 illustrates a user interface displaying the tasks in a hierarchical format, according to one embodiment.

FIG. 10 illustrates a user interface displaying the tasks of a project using aggregation, according to one embodiment.

FIG. 11 is a block diagram of an exemplary computer system according to one embodiment.

### DETAILED DESCRIPTION

Embodiments of techniques for synchronizing data related to workflow are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

A task represents a unit of work. A task can be a job or activity, performed in any field or domain. Each task has certain properties associated with it, which include information associated with the task. Lifecycle of the task spans from start to complete and the task can be in various statuses or states in its entire lifecycle. The lifecycle of a task is governed by a workflow. Workflow is a set of steps or actions or statuses and transitions that a task goes through during its lifecycle. Workflow typically represents a business process. Each workflow can be associated with a particular project or a task. In one embodiment the workflow is a project management workflow, where the workflow is specifically defined for project management. Each stage in a task corresponds to one of the actions or statuses in the workflow. A task can exist in one step or action at any point in time. When a task is transitioned to a particular step or action, its action field and other properties associated with the task can be updated. A transition is a link between two actions. For a task to progress from one particular action to another, a transition must exist that links the two actions. It should be appreciated that, various embodiments described herein can be performed on any tasks, in any field of work, which can be governed by a workflow, pertinent to that field of work.

In one embodiment, workflow can be customized to define any number of actions and transitions. Customization in workflows can be performed by defining actions and transitions based on the business needs. In one embodiment, workflows can be developed using any programming language, based on any business requirement. Such workflows are user defined workflows and can be changed at run time by modifying (for example, adding or removing) actions and transitions. User defined workflows can be developed to design complex workflows to suit various fields of technology such as manufacturing, production, etc. It should be appreciated that any type of workflow with any number of actions can be associated with a task or a project.

In one embodiment, iterative and incremental development approach can be used for software development. An iterative approach enables development of software in an incremental fashion. Thus teams using iterative approach gain the advantage of learning from a previous iteration of software development. Typically, in an iterative approach, incremental development involves quick deliverables at short intervals. The iterative approach is started with a simple implementation of a subset of the software requirements, and iteratively enhanced, by evolving the versions of software deliverables, until the complete solution is implemented.

In general, iteration requires a modification in the design or requirements along with adding new functional capabilities. To guide such an evolving iteration process, a task list is created that contains a record of all the tasks to be performed for that iteration. Such tasks can include new features, enhancements, redesign, issues, etc. Agile software development is based on iterative and incremental development, where the task list created in every iteration process, evolves through collaboration between teams. Agile approach promotes interaction throughout the development cycle.

One approach in agile software development is scrum, which is used for managing software projects. The scrum team is a self-organizing team including a scrum master and a product owner. Scrum master acts as a mentor for the team and the product owner represents a business user or customer in guiding the team to build the right product. Every member of the team collaborates on a physical dashboard with the task list to decide on their respective tasks and responsibilities.

Scrum projects are time bound iterations which are generally a month long. The list of tasks to do in the product is called a product backlog. The product backlog is a prioritized task list containing short description of all the functionalities desired in the product. Typically, product backlog comprises the different types of items such as features, enhancements, issues, technical work, redesign, etc. Each item in this list is linked to a task. The task has properties like estimated time, spent time, status, assignee, etc.

Typically, tasks are materialized in a physical dashboard and updated on a daily basis by the scrum team. Daily scrum meet is attended by all team members, including the scrum master and the product owner. This meeting is generally time bound to 15 to 30 minutes. During the meet, team members share the progress of their tasks, take up new tasks and identify any impediments to progress. A daily scrum serves to synchronize the work of team members, as they discuss using the physical dashboard. At the end of daily scrum, the physical dashboard indicates the status of the tasks as specified by the team members. Typically, the task information in the physical dashboard that is updated on a daily basis is not recorded or documented and is eventually lost. Managing huge product backlog on a physical dashboard makes it cumbersome, non-scalable and inhibits managing and tracking various stages of the product backlog.

Task information in the physical dashboard may need to be recorded or documented to track the project status. In such a scenario, scrum master or any other team member is required to perform double booking by first marking the status changes of the task in the physical dashboard, and then documenting or recording in a digital file. For example, after a daily scrum, if the scrum master fails to document the task status, a discrepancy arises between the task information in the physical dashboard and the digital file. Double booking requires additional effort and is time consuming.

Thus, enterprises require live centralized data in order to track project status. Project status needs to be tracked for appropriate measures to be taken on an on-need basis. Multiple teams and projects have dependencies on each other and having them in a centralized place allows links to be created between them. Live centralized data has numerous advantages such as manageability, speed in computing, portability, providing up to date statistics, integration with other products, and the like. Maintaining live centralized data requires single entry of task information and the overhead of double booking is avoided.

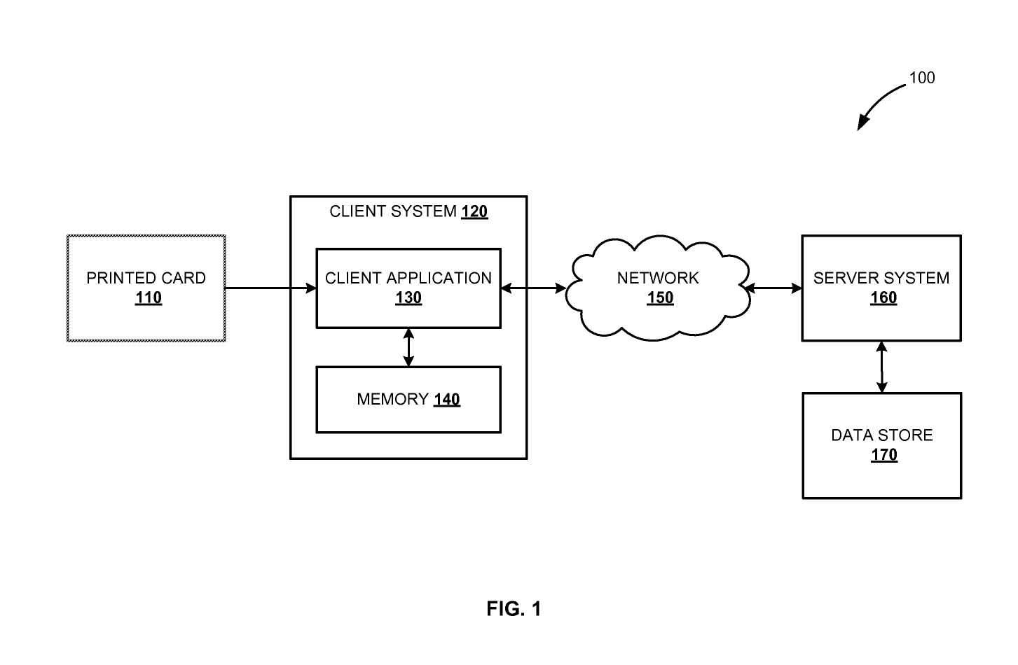

FIG. 1 is a block diagram illustrating an exemplary environment for synchronizing data related to workflow, according to an embodiment. The block diagram 100 is shown containing client system 120, client application 130, memory 140, network 150, server system 160, printed card 110 and data store 170. Merely for illustration, only a representative number and type of systems is shown in FIG. 1. Many environments often contain many more systems (e.g., more server systems), both in number and type, depending on the purpose for which the environment is designed. Each system/device of FIG. 1 is described below in further detail.

Network 150 provides connectivity between server system 160 and client system 120. Network 150 may be implemented using protocols such as Transmission Control Protocol (TCP) and/or Internet Protocol (IP), well known in the relevant art. In general, in TCP/IP environments, a TCP/IP packet is used as a basic unit of transport, with the source address being set to the TCP/IP address assigned to the source system from which the packet originates, and the destination address set to the TCP/IP address of the target system to which the packet is to be eventually delivered.

Server system 160 represents a server, such as a web/application server, executing software applications, for example enterprise application, such as project management application capable of performing tasks requested by clients/users. In general, server system 160 receives requests for performing desired tasks from users using client system 120, performs the requested tasks on data maintained internally or on external data, for example, data stored in data store 170 and then sends the result of performance of the tasks to the requesting client system 120.

The client system 120 can be a computing device such as a mobile phone, desktop or portable computer, or a tablet computer used by end users to generate requests directed to client application 130, executing in the client system 120. The requests may be generated using appropriate user interfaces. In general, an end-user system requests the client application 130 for performing desired tasks and receives corresponding responses containing the results. The client application 130 also requests the server system 160 for performing specific tasks and receives corresponding response from the server system 160. Requests may be sent in the form of an IP packet directed to the desired server system 160, with the IP packet including data identifying the desired tasks in the payload portion.

The client system 120 includes a client application 130. The client application 130 executes in the client system 120, and provides a user interface, for example, based on display and inputs such as touch, keypad and pointer device. User interacts with the user interface provided in the client system 120 and thus the enterprise application, for example project management application, executing in the server system 160. In one embodiment, the client application 130 can be application software comprising a set of instructions, published on a web or application server, which can be downloaded and installed on the client system 120. For example, client application 130 can be a mobile application available for download in an application store, provided by a vendor or any service provider. In another embodiment, the client application 130 can be accessed over a network 150 and executed on the client system 120, for example as an on-demand software such as, software as a service (SaaS).

The client system 120 also includes a memory 140. The memory 140 stores the data, fetched from the server system 160, to enable the user to perform operations on the client application 130. Memory 140 represents a non-volatile storage such as a flash memory. The result of user operation is stored in the memory 140 and subsequently synchronized with the data store 170. The memory 140 may be internal to the client system 120, such as flash drive. In one embodiment the memory 140 may be external to the client system 120. Data store 170 represents a non-volatile storage, facilitating storage and retrieval of a collection of data, by enterprise applications executing in server system 160.

In one embodiment, client application 130 generates a print ready card, by embedding machine-readable representation such as quick response (QR) code. The QR code is merely exemplary, various types of machine readable representations such as bar code, SPARQCode, maxi code, etc., can be used. Print ready card is encoded with a unique identifier corresponding to the task. Unique identifier can be a combination of alphabets, numerals, special characters or symbols, which uniquely identifies the task. Print ready card is sent to a printer resulting in a printed card 110. Printed card 110 represents a physical card, embedding machine-readable representation of data, corresponding to a task. Printed card 110 is used in scrum meetings where the client application 130 receives an image input of the printed card 110, to process properties associated with the task. Unique identifier encoded in the machine-readable representation, is extracted from the received image, to identify the corresponding task.

The client application 130 can display a product backlog, fetched from the project management application. The project management application is executing in the server system 160. Information fetched from the server system 160 is stored in the memory 140 of the client system 120. Stored information is used by the client application 130, for further processing and display on the client system 120. Tasks are created in the project management application, where each task is associated with a unique identifier. In one embodiment, the project management application is a web based application and each task is invoked by a uniform resource locator (URL). The URL includes the unique identifier of the task, to identify and invoke that particular task. Thus URL formed is unique for every task. Example of an URL is “https://<server>/browse/<task unique identifier>”.

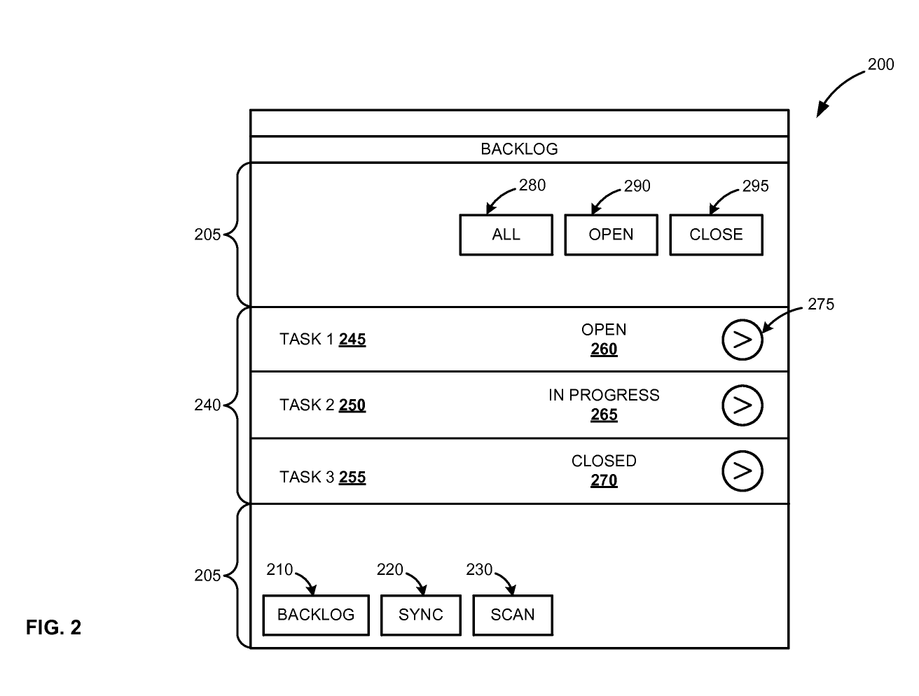

FIG. 2 illustrates a user interface 200 for displaying tasks 240, associated with the product backlog, in a client system 120. The user interface 200 has a ribbon interface 205 at the top and bottom of the screen, providing frequently used options such as ‘backlog’ 210, ‘sync’ 220, ‘scan’ 230, ‘all’ 280, ‘open’ 290, etc. After a ‘backlog’ 210 option is selected by a user, corresponding tasks 240 are displayed, on the user interface 200. Each task is associated with a unique identifier, for example, “task 1” 245 is identified by the unique identifier TSK-1. For example, “task 1” 245 is shown in an ‘open’ 260 action representing an open status, “task 2” 250 in an ‘in progress’ 265 action representing an in progress status and “task 3” 255 in a ‘closed’ 270 action representing a closed status. User can view details of the individual tasks by selection of an arrow icon 275, corresponding to each task. User can view the details, for example, properties of “task 1” 245 by selection of arrow icon 275.

User may select ‘all’ 280 option, to view all the tasks in the backlog, ‘open’ 290 option to view all the tasks which are in ‘open’ 260 action and ‘close’ 295 option to view all the tasks which are in closed action states. ‘Open’ 290 and ‘close’ 295 options act as a filter, where tasks matching the selected action statuses are displayed, while filtering the rest. ‘Sync’ 220 option is used to synchronize data in the server system 160 and the client application 130. Client application 130 synchronizes the information updated in the client system 120, with the server system 160 and vice versa. It should be appreciated that any other frequently required operations can be added as an option to the ribbon 205 of the user interface 200, for example, ‘My backlog’ option.

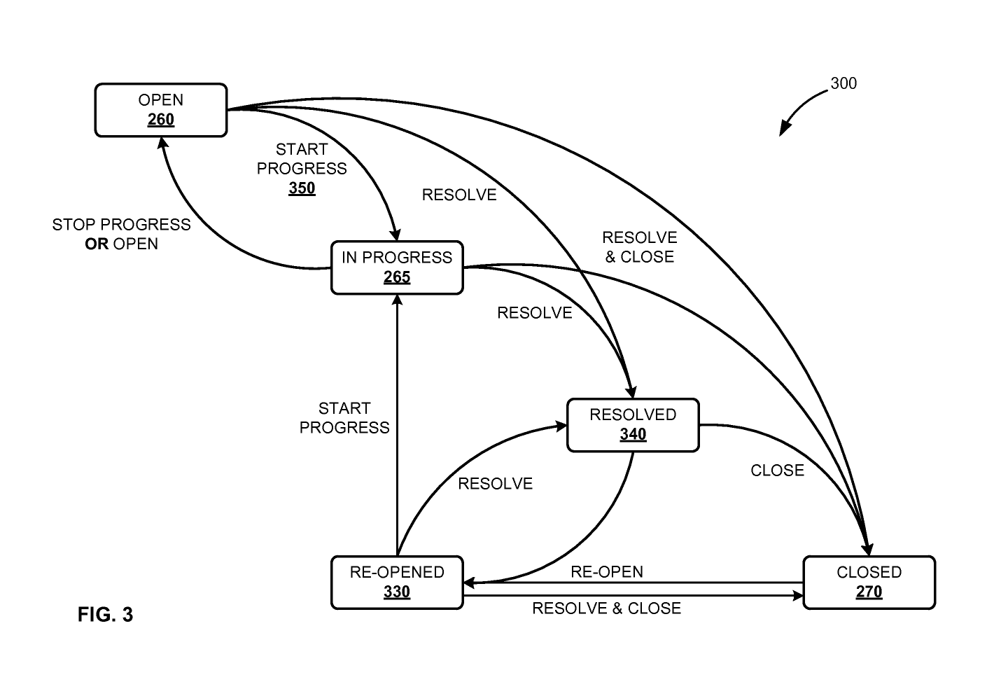

FIG. 3 illustrates a workflow 300 that is associated with a task, according to one embodiment. Workflow 300 defines the actions and the transitions among actions, for example the project management workflow. Workflow 300 is initially shown in an ‘open’ 260 action and can be transitioned to one of the actions such as ‘in progress’ 265 action, ‘resolved’ 340 action or ‘closed’ 270 action. For example, ‘open’ 260 action, can be transitioned to ‘in progress’ 265 action, based on the transition ‘start progress’ 350, defined in the workflow. The ‘in progress’ 265 action can be transitioned to ‘resolved’ 340 action, ‘closed’ 270 or ‘open’ 260 action. Similarly ‘resolved’ 340 action can be transitioned to ‘closed’ 270 action or ‘re-opened’ 330 action. ‘Open’ 260 action indicates a logical beginning and ‘closed’ 270 action indicates a logical end to the workflow. The ‘re-opened’ 330 action is similar to the ‘open’ 260 action, and can be subsequently transitioned to ‘in progress’ 265 action, ‘resolved’ 340 action or ‘closed’ 270 action.

At any given point of time, each task can remain in one of the statuses or actions in the workflow 300, as described above. The task can be transitioned from one action to another, and such transition is defined by the workflow. As an example, consider that the workflow 300 is associated with “task 1” 245. Initially “task 1” 245 is in ‘open’ 260 action and “task 1” 245 can be transitioned to one of actions such as ‘in progress’ 265 action, ‘resolved’ 340 action or ‘closed’ 270 action, as defined in the workflow 300. Thus, lifecycle of “task 1” 245 is governed by the workflow 300.

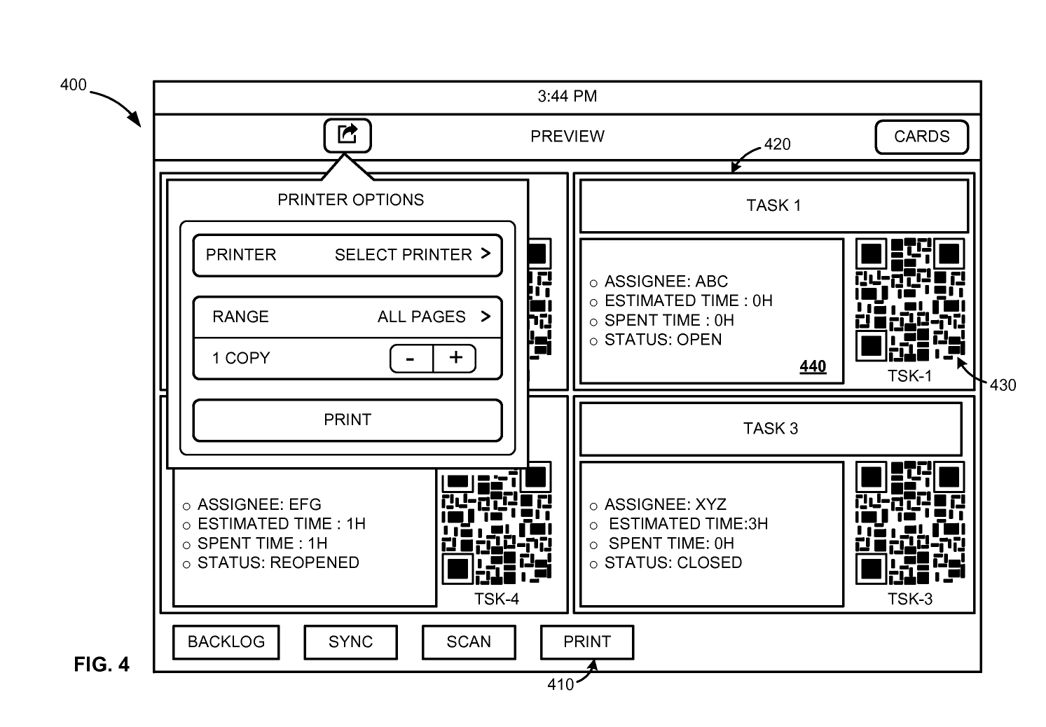

FIG. 4 illustrates a user interface 400 for generating print ready card for the task, according to one embodiment. Although the user interface 400 is explained in reference to display on the mobile device, the user interface 400 may be designed, to render the client application 130 in a desktop screen, a portable computer screen, and the like. Each task available in the backlog 210, as shown in FIG. 2, can be printed, to be used in a meeting such as a scrum meeting. Client application 130 generates a print ready card 420, corresponding to each task and a user can preview the card before printing. Print ready card 420, for “task 1” 245, is identified by a unique identifier TSK-1. The print ready card 420, for “task 1” 245 has properties 440, such as assignee, estimated time, spent time and status, along with embedded machine readable QR code 430.

The QR code 430 for “task 1” 245, contains an URL in which the unique identifier i.e., TSK-1 of “task 1” 245, as used by the project management application, executing in server system 160 is encoded. For example, the QR code 430 for “task 1” 245, contains the URL “https://<server>/browse/TSK-1”. This URL is used to identify and invoke “task 1” 245 in the client application 130. QR code 430 is designed in such a way that it can be used to display “task 1” 245 or open the webpage of “task 1” 245, in the client application 130 and is capable of being scanned by any QR readers.

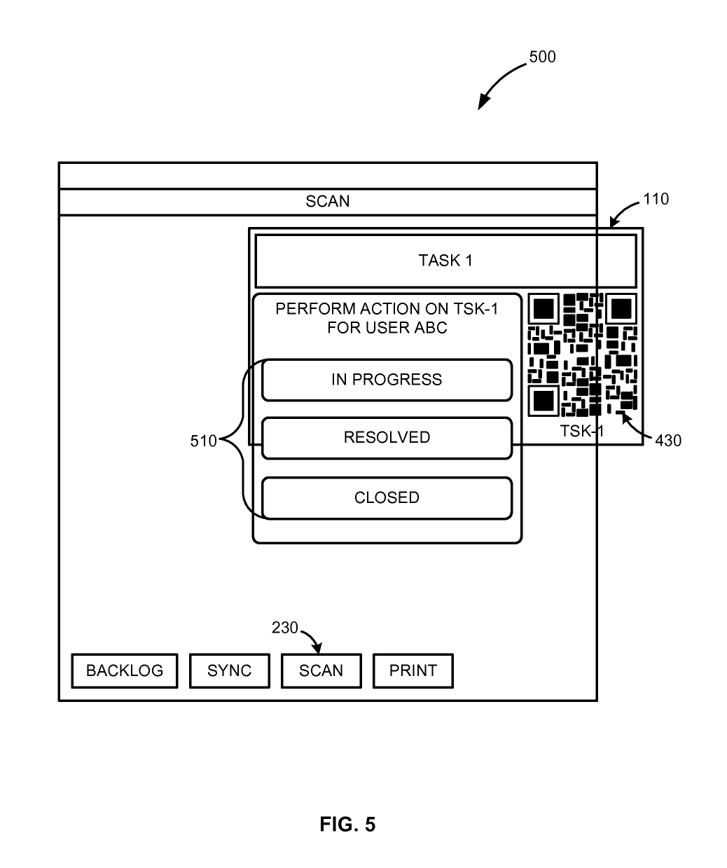

In the scrum meeting, team members discuss the progress of various tasks, using the printed cards on the physical dashboard. During the scrum meeting, progress of “task 1” 245, is discussed and the team member indicates that the “task 1” 245 is “in progress” 265 status. FIG. 5 illustrates a user interface 500, displaying a set of actions 510, associated with the workflow 300, corresponding to the scanned printed card 110, of “task 1” 245, according to one embodiment. In one embodiment, a responsible person such as a scrum master can select ‘scan’ 230 option to scan the QR code 430, in the printed card 110 of “task 1” 245, using a camera in the client system 120, for example, using the camera in a mobile phone. Client application 130 automatically extracts the unique identifier, from the scanned image and identifies the task corresponding to the extracted unique identifier.

In one embodiment, the client application 130 includes a QR reader (not shown), to scan the image of the QR code 430, and parse the content encoded in the QR code 430. The client application 130 receives an image input from the printed card 110, of “task 1” 245. The QR reader obtains the URL “https://<server>/browse/TSK-1”, from the QR code 430. The client application 130 parses the URL to extract the unique identifier ‘TSK-1’. The client application 130 performs a lookup in the memory 140, to verify if the “task 1” 245 (TSK-1) exists. If an entry is found, the client application 130 queries the server system 160, to obtain the list of available actions 510, associated with TSK-1. The retrieved list of actions 510, ‘in progress’, ‘resolved’, and ‘closed’, associated with TSK-1 is displayed on the user interface 500. User is thus prompted with the list of actions 510 retrieved from the server system 160.

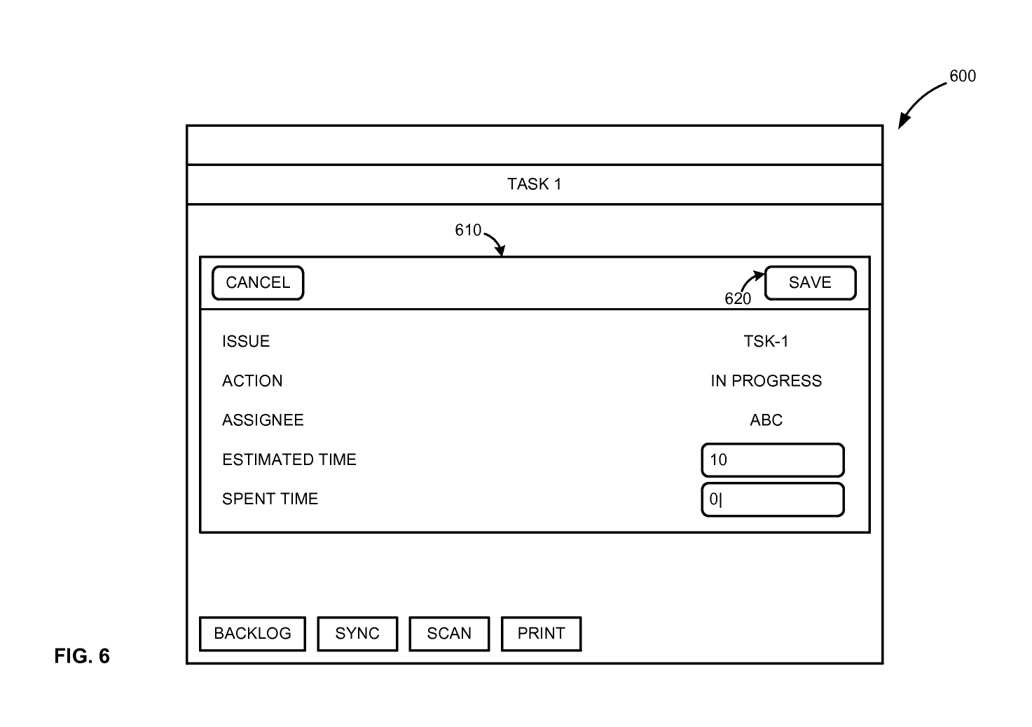

FIG. 6 illustrates a user interface 600, displaying information associated with a selected action, according to one embodiment. Window 610 is displayed with action ‘in progress’, in response to a user selection of action ‘in progress’, as illustrated in 510 of FIG. 5. Window 610 is displayed with action ‘in progress’, along with the properties (e.g., 440 of FIG. 4) associated with TSK-1. User can update the properties such as estimated time, spent time, etc., and select the ‘save’ 620 option to update the details. After saving, data is updated first in the data store 170 and then in the memory 140. Thus at the end of this ‘save’ 620 operation, data stored in both the data store 170 and memory 140 will contain identical information.

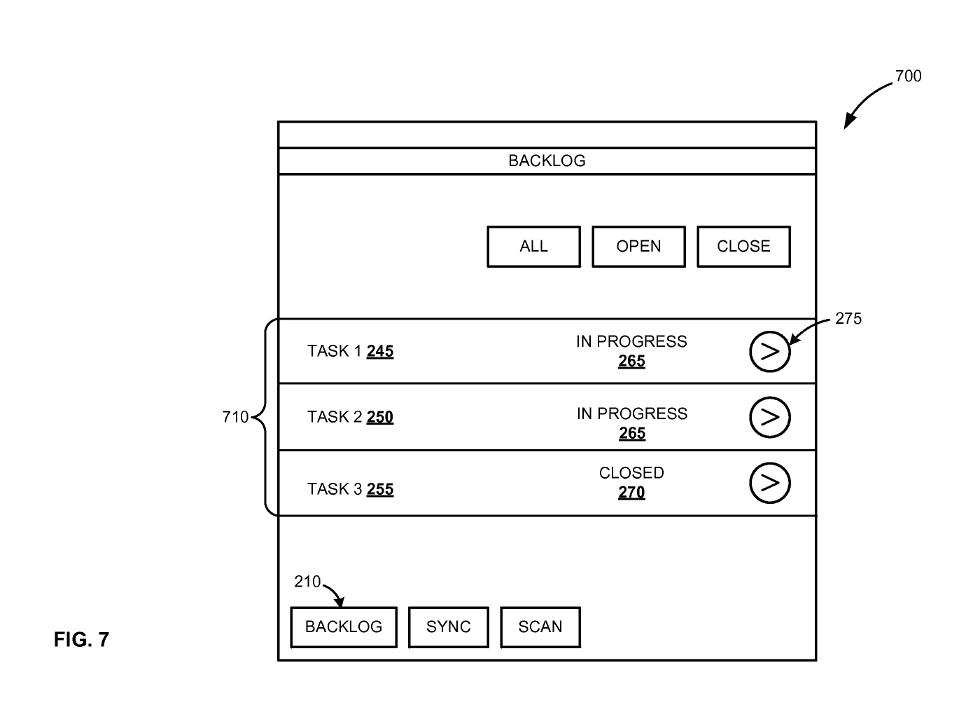

FIG. 7 illustrates a user interface 700, displaying updated tasks 710, according to one embodiment. At the end of ‘save’ operation, as illustrated in 620 of FIG. 6, TSK-1 (“task 1” 245), is updated to ‘in progress’ 265 action in the user interface 700. User can choose to select the arrow icon 275, to view the properties (e.g., 440 of FIG. 4) associated with the updated TSK-1 (“task 1” 245″). Thus, teams synchronize their physical representation of tasks with the client application 130, executing in client system 120 and thus with the project management application executing in the server system 160.

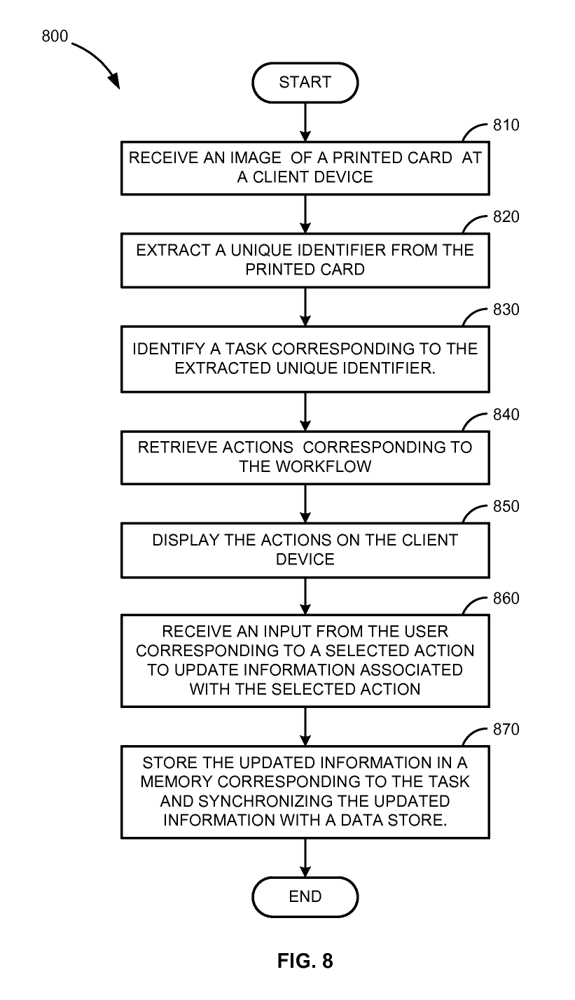

FIG. 8 illustrates a flow diagram 800 of a method, to synchronize data associated with the workflow 300. At 810, image of a printed card 110 corresponding to a task is received at a client system 120 (e.g., client device such as a mobile phone). Image of the printed card is captured by the client application 130. A unique identifier corresponding to the task is embedded as a machine readable code 430 in the printed card. At 820, the unique identifier is extracted from the image of the printed card. At 830, the unique identifier, enables identifying the corresponding task. Each task is associated with a workflow comprising, a set of actions and transitions from one action to the other.

At 840, all the actions corresponding to the workflow, associated with the identified task, are retrieved. At 850, retrieved set of actions, for example set of actions 510, are displayed on the client device. User can select one of the actions from the displayed set of actions, based on the current status of the task. At 860, user input corresponding to the selected action is received. User input includes updated information 610 associated with the selected action. At 870, the updated information is stored in a memory 140 corresponding to the task and the stored updated information is synchronized with a data store 170.

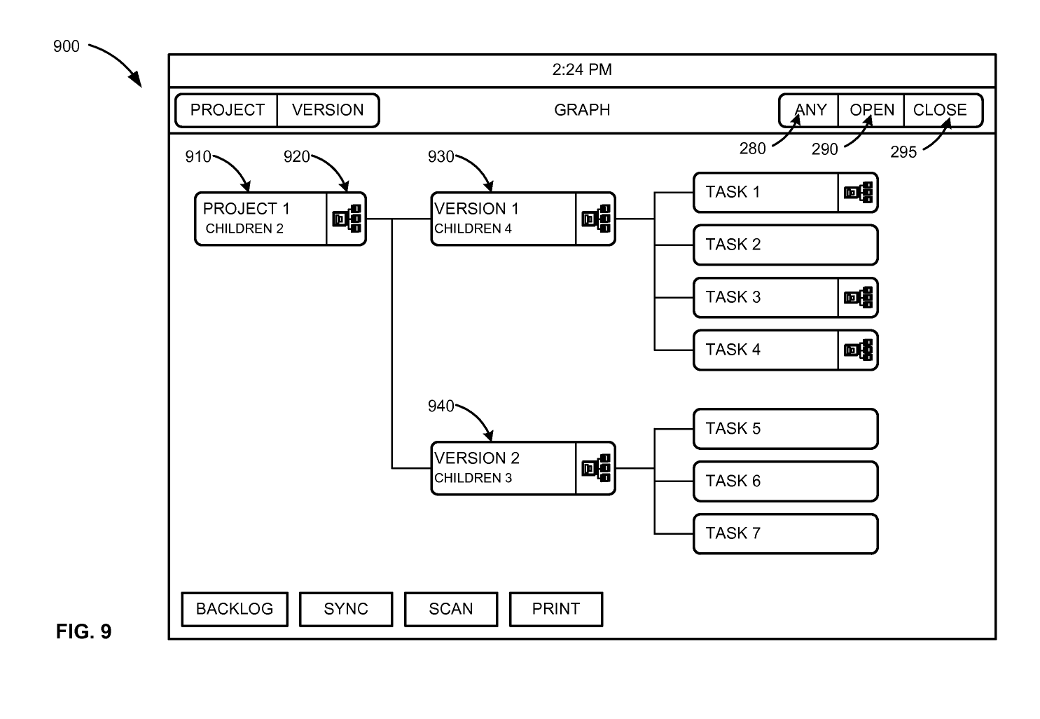

In one embodiment, the client application 130 displays the tasks in a simplified and efficient manner. Projects could have multiple components or modules and the components could have tasks, or alternatively, projects could have multiple versions and each version could have tasks. In such a scenario, graphical representation of data becomes complex specifically in a small display screen, such as in the mobile phone. FIG. 9 illustrates a user interface 900 of the client application 130 for displaying the tasks of a project in a hierarchical format. Examples for hierarchical format include a tree and an organization chart. The hierarchical format in FIG. 9 includes a project node at a first level, version nodes at a second level and the task nodes at a third level. The nodes at the first level indicate the number of nodes at the second level. For example, the ‘project 1’ 910 node, displays the number of version nodes i.e., ‘children’ to be ‘2’. ‘Version 1’ 930 node, displays the number of task nodes to be ‘4’ and ‘version 2’ 940 node, displays the number of task nodes to be ‘3’.

In one embodiment, when the user interface 900 is first accessed, only the project node 910 is visible. An expansion icon 920, on each node allows the user to expand or collapse the view of the next level of nodes in the hierarchical view. Simplifying the display of the nodes in the hierarchical view and indication of the number of nodes at the next level gives a better overview of project and associated tasks.

In one embodiment filters can be used to simplify the representation of the hierarchical view by hiding certain nodes. Filters can be used to specify criteria which when applied on the input results in a desired output. Filtering can be performed on any of the properties associated with the task such as estimated time, assignee, etc. When the client application 130 queries a node for its child nodes, only the child nodes matching the filter criteria would be retained for display on the user interface 900. For example, when a user selects ‘open’ 290 option in FIG. 9, all the tasks corresponding to ‘open’ action status is filtered and displayed to the user in a hierarchical format.

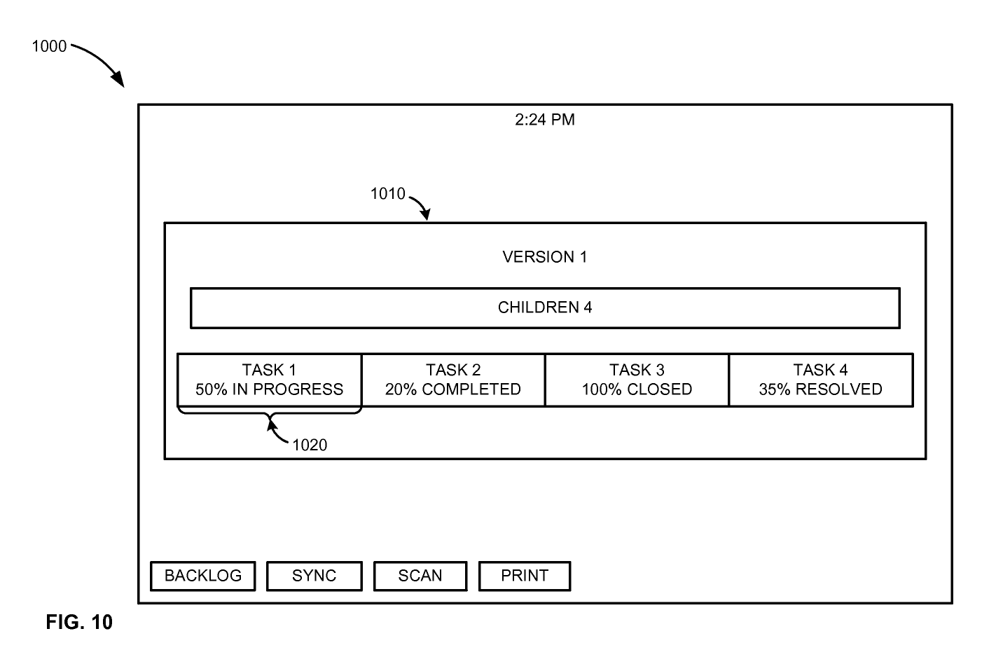

In one embodiment aggregation can be used to display the level of completion. FIG. 10 illustrates a user interface 1000 of the client application 130 for displaying the tasks of a project using aggregation. Certain task properties are represented as numeric data. The hierarchical tree can be traversed and aggregates for the specified task properties are calculated and displayed. Such aggregation can be represented as a progress indicator, for example, progress bar to display the progress or completion of a node. For example, the progress of tasks in “version 1” is displayed as shown in 1010. Progress of tasks at the child level such as “task 1” 245, “task 2” 250, “task 3” 255 , etc., are represented using progress indicator 1020 to display the progress or completion of each task. For example, when the user needs to know the remaining hours for each task type, progress indicator display is more helpful.

In one embodiment, if the client device has a touchscreen, a tap operation can be performed on the nodes. By tapping a node outside of its area, a detailed view of the node can be obtained. Double tapping a node can be used to zoom in and out, the nodes in the hierarchical tree. By double tapping a node, the user can select the node as being the new root of the visualized tree and view the complete tree. Double tapping acts like a toggle where subsequent double tapping on the node zooms out the view.

The various embodiments described above have a number of advantages for example the complexity of user interface in the project management tool is hidden from the end user, by providing a simple interface to the user in the client device. Simplified view of complex tree can be displayed in a small display screen (for example, mobile phone). Projects are managed in a centralized location and various other project management tools can be integrated with the client application. Task updated using the client application takes one fourth of the time required in comparison to a manual task updation. Client application is portable and flexible to be used in any remote location thus improving efficiency, performance and productivity of enterprise users.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (ASICs), programmable logic devices (PLDs) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

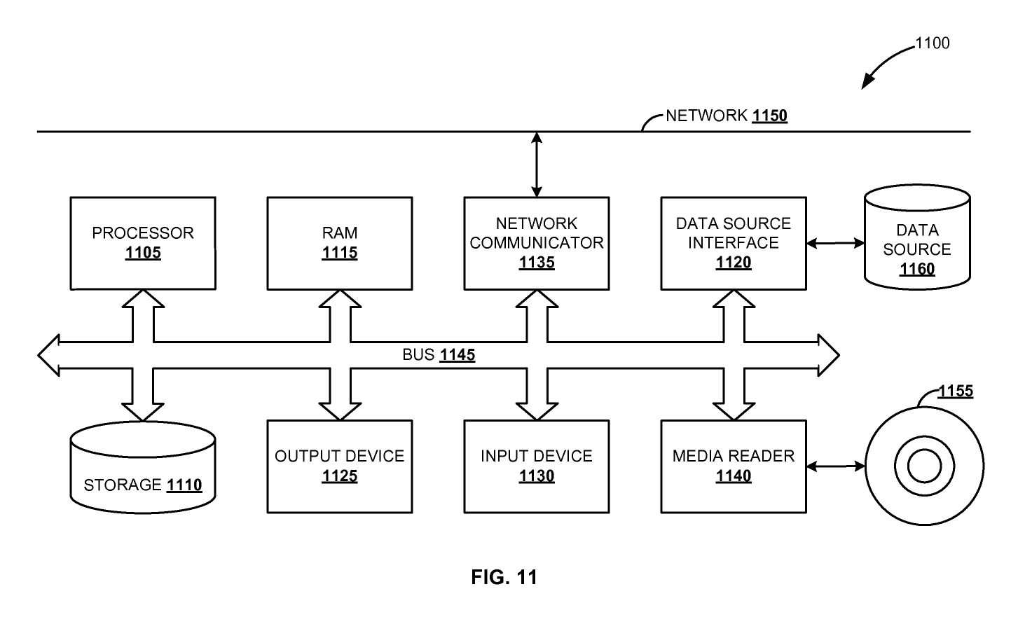

FIG. 11 is a block diagram of an exemplary computer system 1100. The computer system 1100 includes a processor 1105 that executes software instructions or code stored on a computer readable storage medium 1155 to perform the above-illustrated methods. The computer system 1100 includes a media reader 1140 to read the instructions from the computer readable storage medium 1155 and store the instructions in storage 1110 or in random access memory (RAM) 1115. The storage 1110 provides a large space for keeping static data where at least some instructions could be stored for later execution. The stored instructions may be further compiled to generate other representations of the instructions and dynamically stored in the RAM 1115. The processor 1105 reads instructions from the RAM 1115 and performs actions as instructed. According to one embodiment, the computer system 1100 further includes an output device 1125 (e.g., a display) to provide at least some of the results of the execution as output including, but not limited to, visual information to users and an input device 1130 to provide a user or another device with means for entering data and/or otherwise interact with the computer system 1100. Each of these output devices 1125 and input devices 1130 could be joined by one or more additional peripherals to further expand the capabilities of the computer system 1100. A network communicator 1135 may be provided to connect the computer system 1100 to a network 1150 and in turn to other devices connected to the network 1150 including other clients, servers, data stores, and interfaces, for instance. The modules of the computer system 1100 are interconnected via a bus 1145. Computer system 1100 includes a data source interface 1120 to access data source 1160. The data source 1160 can be accessed via one or more abstraction layers implemented in hardware or software. For example, the data source 1160 may be accessed by network 1150. In some embodiments the data source 1160 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. An article of manufacture including a non-transitory computer readable storage medium to tangibly store instructions, which when executed by a computer, cause the computer to:
receive an image of a printed card at a client device;
extract a unique identifier from the image;
identify a task corresponding to the extracted unique identifier, wherein the task is associated with a project management workflow;
retrieve one or more actions corresponding to the workflow ;
display the one or more actions on the client device;
receive an input from a user corresponding to a selected action to update information associated with the selected action; and
store the updated information in a memory corresponding to the task.

2. The article of manufacture of claim 1, wherein each action in the workflow represents a state of the task and a transition links two of the actions.

3. The article of manufacture of claim 1, further comprising instructions which when executed by the computer further causes the computer to:
display a plurality of tasks in a hierarchical format, wherein a first-level task indicates number of corresponding second-level tasks.

4. The article of manufacture of claim 1, wherein the storing further comprises:
synchronizing the updated information in a data store.

5. The article of manufacture of claim 1, further comprising instructions which when executed by the computer further causes the computer to:
generate a print ready card by embedding machine-readable representation of data comprising a uniform resource locator (URL) containing the unique identifier.

6. The article of manufacture of claim 5, wherein the machine-readable representation is a quick response (QR) code.

7. The article of manufacture of claim 1, further comprising instructions which when executed by the computer further causes the computer to:
generate a print ready card comprising an encoded unique identifier.

8. A computer implemented method for synchronization data related to workflow, the method comprising:
receiving an image of a printed card at a client device;
extracting a unique identifier from the image;
identifying a task corresponding to the extracted unique identifier, wherein the task is associated with a project management workflow;
retrieving one or more actions corresponding to the workflow ;
displaying the one or more actions on the client device;
receiving an input from a user corresponding to a selected action to update information associated with the selected action; and
storing the updated information in a memory corresponding to the task.

9. The method of claim 8, wherein each action in the workflow represents a state of the task.

10. The method of claim 8, further comprising:
displaying a plurality of tasks in a hierarchical format, wherein a first-level task indicates number of corresponding second-level tasks.

11. The method of claim 8, wherein the storing further comprises:
synchronizing the updated information with a data store.

12. The method of claim 8, further comprising:
generating a print ready card by embedding machine-readable representation of data comprising a uniform resource locator (URL) containing the unique identifier.

13. The method of claim 12, wherein the machine-readable representation is a quick response (QR) code.

14. The method of claim 8, further comprising:
generating a print ready card comprising an encoded unique identifier.

15. A computer system for synchronizing data related to workflow, comprising:
a computer memory to store program code; and
a processor to execute the program code to:
receive an image of a printed card at a client device;
extract a unique identifier from the image;
identify a task corresponding to the extracted unique identifier, wherein the task is associated with a project management workflow;
retrieve one or more actions corresponding to the workflow;
display the one or more actions on the client device;
receive an input from a user corresponding to a selected action to update information associated with the selected action; and
store the updated information in a memory corresponding to the task.

16. The system of claim 15, wherein each action in the workflow represents a state of the task.

17. The system of claim 15, wherein the processor further executes the program code to:
display a plurality of tasks in a hierarchical format, wherein a first-level task indicates number of corresponding second-level tasks.

18. The system of claim 15, wherein the storing further comprises:
synchronize the updated information in a data store.

19. The system of claim 15, wherein the processor further executes the program code to:
generate a print ready card by embedding machine-readable representation of data comprising a uniform resource locator (URL) containing the unique identifier.

20. The system of claim 19, wherein the machine-readable representation is a quick response (QR) code.
